(19) United States
(12) Patent Application Publication
(10) Pub. No.: US 2023/0168991 A1
(43) Pub. Date: Jun. 1, 2023

(54) ANNOTATING RUNTIME DATA

(71) Applicant: Hewlett-Packard Development Company, L.P., Spring, TX (US)

(72) Inventors: Mauricio Coutinho Moraes, Porto Alegre (BR); Jhonny Marcos Acordi Mertz, Porto Alegre (BR); Rodrigo Uzun Fleischmann, Porto Alegre (BR)

(21) Appl. No.: 17/537,961

(22) Filed: Nov. 30, 2021

(51) Int. Cl. G06F 11/36

(52) U.S. Cl. CPC G06F 11/3624

(57) ABSTRACT

In some examples, a computing device can include a processing resource and a memory resource storing instructions to cause the processing resource to receive an audit request for a web application, locate runtime data located in an execution trace of the web application in response to receiving the audit request, where the execution trace is generated by an omniscient debugger monitoring the web application, and annotate the runtime data in response to the runtime data being located.

### BACKGROUND

Computing devices can allow a user to utilize computing device operations for work, education, gaming, multimedia, and/or other uses. Computing devices can be portable to allow a user to carry or otherwise bring the computing device with while in a mobile setting. A computing device can allow a user to utilize computing device operations for work, education, gaming, multimedia, and/or other general use in a mobile setting.

### BRIEF DESCRIPTION OF THE DRAWINGS

FIG. 1 illustrates an example of a system for annotating runtime data consistent with this disclosure.

FIG. 2 illustrates an example of annotated runtime data included in source code in an execution trace consistent with this disclosure.

FIG. 3 illustrates an example of a computing device for annotating runtime data consistent with this disclosure.

FIG. 4 illustrates a block diagram of an example system for annotating runtime data consistent with this disclosure.

FIG. 5 illustrates an example of a method for annotating runtime data consistent with this disclosure.

### DETAILED DESCRIPTION

A user may utilize a computing device for various purposes, such as for business and/or recreational use. As used herein, the term “computing device” refers to an electronic system having a processing resource and a memory resource. Examples of computing devices can include, for instance, a laptop computer, a notebook computer, an all-in-one (AIO) computer, an imaging device, among other types of computing devices.

Computing devices execute sets of instructions in order to perform different computing operations. Certain computing operations include utilizing web applications. As used herein, the term “web application” refers to a set of instructions comprising application software that executes on a web server. A web application is accessible by a computing device through a portal, such as a browser. For example, a computing device (e.g., a client computing device) is provided services by the web server via the web application accessed through the browser. Such services can include electronic mail (e.g., email), online sales, banking, among other types of services.

When developing a web application, audit logs are utilized to generate and store events associated with the web application over a period of time. Such audit logs are utilized by a user to view the events. For example, the user may view an audit log to examine suspicious activity and/or diagnose and troubleshoot issues experienced by the web application (e.g., debug the web application).

Certain data may be useful for the user when viewing the audit log. For example, user information and/or security information included in the web application may be useful for the user to view a sequence of steps taken by the web application when the web application executes instructions to perform computing operations. Such data can be runtime data. As used herein, the term “runtime data” refers to information relating to execution of a set of instructions associated with a web application.

In previous approaches, in order to audit a web application for runtime data, a user has to manually locate the runtime data within source code of the web application. As used herein, the term “source code” refers to a collection of instructions written in a human-readable programming language. For example, a user would have to manually review source code of a web application and manually annotate the runtime data the user locates within the source code. When such runtime data is located and annotated, the web application can be audited to generate and store events in an audit log for review by a user.

Accordingly, previous approaches utilizing manual review of source code of web applications to locate runtime data results in large amounts of time spent by users (e.g., developers) reviewing source code of web applications. Such an approach can be time consuming and expensive, especially in instances of large codebases.

Annotating runtime data according to the disclosure can allow for location of runtime data utilizing certain debugging approaches, allowing for a reduction in time developing web applications. Such an approach can allow for web application auditing that can take significantly less time and effort as compared with previous approaches, especially in instances of web applications with large codebases.

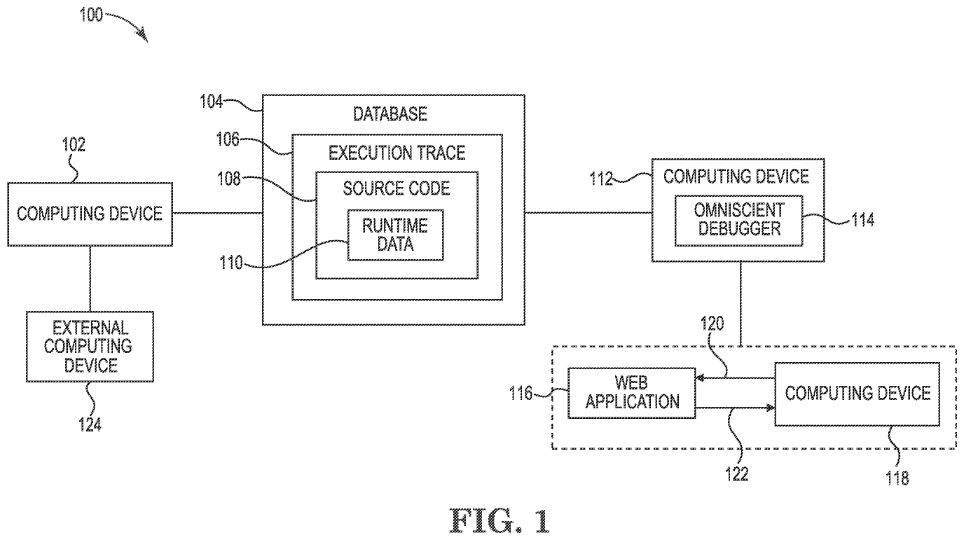

FIG. 1 illustrates an example of a system 100 for annotating runtime data consistent with this disclosure. The system 100 can include computing device 102, database 104, computing device 112, web application 116, computing device 118, and computing device 124.

During development of the web application 116, a user (e.g., a developer) may desire to audit the web application 116. For example, source code of the web application 116 may include a variable “fullname”, and the user may be interested in what ways the values stored in the column of the variable “fullname” are used by the web application 116. Annotating runtime data according to the disclosure can allow the user to easily determine such information via an audit of the web application 116, as is further described herein.

The system 100 can include a computing device 118 that communicates with the web application 116. Communicating with the web application 116 by the computing device 118 includes transmitting, by the computing device 118 to the web application 116, a Hypertext Transfer Protocol (HTTP) request 120 to the web application 116. As used herein, the term “HTTP request” refers to a message sent by a client to a host to access a resource at the host. For example, the computing device 118 transmits the HTTP request 120 to the web application 116 in order to access a service at the web application 116.

The web application 116 provides the service to the computing device 118 with an HTTP response 122. As used herein, the term “HTTP response” refers to a message sent by a host to a client to provide a requested resource to the client, inform the client that the request has been performed, or to inform the client that an error occurred in processing a request by the client. In other words, the computing device 118 receives the HTTP response 122 from the web application 116.

The computing device 118 can communicate with the web application 116 in a controlled environment. For example, communication between the computing device 118 and the web application 116 can be performed in a non-production environment.

As illustrated in FIG. 1, the system 100 includes a computing device 112. An omniscient debugger 114 is executing on the second computing device 112. As used herein, the term “omniscient debugger” refers to a computer application that assists in detection and/or correction of errors in a different computer application by recording a whole execution history of the different computer application. For example, the omniscient debugger 114 can simulate step-by-step execution of application instructions of an application (e.g., web application 116) forward and/or backwards. Accordingly, the omniscient debugger 114 can provide an execution trace of an application that includes past activity as well as interactive navigation, step-by-step execution, and complete stack inspection capabilities while avoiding having to rerun the application multiple times. Further, the omniscient debugger 114 can allow a user to navigate through the execution history of the application to determine timing execution questions (e.g., When was variable “X” assigned a null value? What was the state of object “Y” when it was passed as an argument to method “foo”? etc.).

Accordingly, the omniscient debugger 114 monitors the web application 116. The omniscient debugger 114 monitors the HTTP requests 120 and the HTTP responses 122 occurring between the web application 116 and the computing device 118 so that the step-by-step execution the web application 116 performs can be reviewed, as is further described herein.

The omniscient debugger 114 generates an execution trace associated with the web application 116. As used herein, the term “execution trace” refers to step-by-step execution of source code of an application as it was executed over time. For example, as the web application receives HTTP requests 120 from the computing device 118 and generates and transmits HTTP responses 122 to the computing device 118, the omniscient debugger 114 records the step-by-step execution of the source code by the web application 116 as it occurs over time in an execution trace. The execution trace accordingly includes source code of the web application 116 as it was executed over a period of time. As such, the execution trace generated by the omniscient debugger 114 includes a recorded history of the web application 116 monitored by the omniscient debugger. The recorded history includes the source code of the web application 116 as it was executed over a period of time.

The execution trace is transmitted by the computing device 112 to the database 104. For example, as illustrated in FIG. 1, the execution trace 106 having the source code 108 of the web application 116 as it was executed over a period of time is located in the database 104. The database 104 is located remote from the computing devices 102, 112, 118, and 124.

Although the database 104 is illustrated in FIG. 1 as including a single execution trace 106, examples of the disclosure are not so limited. For example, the database 104 may include multiple execution traces associated with the web application 116 and/or multiple execution traces associated with other web applications (e.g., not illustrated in FIG. 1).

As mentioned above, a user may desire to audit the web application 116. For example, a user may desire to review an audit log of the web application 116 to examine suspicious activity associated with the web application 116 and/or diagnose and/or troubleshoot issues experienced by the web application 116. The user can utilize the audit to debug the web application 116 in the event the web application 116 experiences an issue. The audit may be utilized to identify runtime data 110 that may be of interest to the user, as is further described herein.

Accordingly, a user can utilize the computing device 124 to transmit an audit request for the web application 116 to the computing device 102. As used herein, the term “audit request” refers to information transmitted to a computing device to cause an audit to occur. The computing device 102 provides runtime data 110 to the computing device 124 for use by the user of the computing device 124 in response to receiving the audit request, as is further described herein.

As mentioned above, the omniscient debugger 114 generates an execution trace 106 having source code 108 and transmits the execution trace 106 to the database 104. In order to provide the runtime data 110, the computing device 102 locates the runtime data 110 located in the execution trace 106 in response to receiving the audit request. Locating the runtime data 110 by the computing device 102 can be performed by various approaches, as are further described herein.

In some examples, the computing device 102 locates the runtime data 110 located in the execution trace 106 via heuristics. As used herein, the term “heuristics” refers to a method of ranking alternatives in a search method at branching steps. Heuristics may utilize predetermined parameters for ranking.

As an example, the computing device 102 may utilize a heuristic that includes a parameter to look for values communicated over a network because such values may be a reflection of what process is being performed and by what device. For instance, the computing device 102 can determine, within the execution trace 106, code within the source code 108 that includes database connection information (e.g., a uniform resource locator (URL) of the database, access information, a user identity used in a database query, etc.) that could be runtime data 110.

As another example, the computing device 102 may utilize a heuristic that includes a parameter to look for values that are communicated over different organizational structures within the source code 108 (e.g., architectural layers, packages, modules, etc.) because such data may be a reflection of auditable activities a user may be interested in. For instance, the computing device 102 can determine, within the execution trace 106, code within the source code 108 that includes methods (e.g., “getUserFullname” and/or “getDisplayName”) where the method getUserFullname belongs to a business structure/layer within the source code 108 and the method getDisplayName belongs to a data structure/layer within the source code 108, and the runtime data 110 could be the user identity that is passed as a parameter to the method getUserFullname. Such code could be included in, for instance, network calls, source code region/boundary calls, etc., and the computing device 102 may locate such runtime data 110 by identifying such runtime data 110 with static analysis techniques of the calls.

In some examples, the computing device 102 locates the runtime data 110 located in the execution trace 106 via a filtering model. As used herein, the term “filtering model” refers to a model trained with training data that makes predictions or decisions. The filtering model can be, for example, a machine learning model in which certain rules are extracted from a set of observations. Filtering models can include, for example, image recognition and rule induction machine learning, principal component analysis, and/or cluster analysis, among other types of filtering models/machine learning techniques.

As an example, the source code 108 can include two parameters including a content type and a username. A filtering model can determine which of the two parameters to be considered as runtime data 110 based on previous observations (e.g., via training data or otherwise). Such code can be identified as runtime data 110.

In some examples, the computing device 102 locates the runtime data 110 located in the execution trace 106 by searching via a predetermined search constraint. As used herein, the term “search constraint” refers to a parameter that restricts a search to a subset of data included in a greater data set. For example, the predetermined search constraint can be a parameter that restricts a search to a certain category of data. For instance, the predetermined search constraint can include a keyword, a value of a variable, metadata information, etc.

As an example, the predetermined search constraint can be a keyword, where the keyword allows the computing device 102 to locate the runtime data 110 by searching via a keyword received as an input. For example, a user may input “username” as an input to search by keyword, and the computing device 102 can determine, within the execution trace 106, whether the source code 108 has any matches to the “username” keyword search, and if so, locate such code as runtime data 110.

As an additional example, the predetermined search constraint can be a value of a variable, where the value of the variable allows the computing device 102 to locate the runtime data 110 by searching via a value received as an input. For example, a user may input “12345” as an input to search by variable value, and the computing device 102 can determine, within the execution trace 106, whether the source code 108 has any matches to the “12345” variable value, and if so, locate such code as runtime data 110.

As a further example, the predetermined search constraint can be metadata information, where the metadata information allows the computing device 102 to locate the runtime data 110 by searching metadata information as an input. For example, a user may wish to know the ways in which values stored in a variable “fullname” are used by the web application 116. The user can input “fullname” as an input to search by metadata information, and the computing device 102 can determine, within the execution trace 106, that the metadata information associated with “fullname” comes from a method titled “rs.getString(“fullname”)”, which is executed inside method “getUserFullname(String)”, which is stored in variable “fullname”, and is concatenated with another value from another method “session.getld( )” that is wrapped in parentheses and prefixed with a blank space, and locate such information as runtime data 110.

Although the predetermined search constraint is described above as including a keyword, a value of a variable, and/or metadata information, examples of the disclosure are not so limited. For example, predetermined search constraints can be any other type of constraint.

In some examples, the computing device 102 locates the runtime data 110 by considering the entirety of the execution trace 106 as runtime data 110.

As mentioned above, the runtime data 110 can be located within different layers within the source code 108 of the web application 116. As used herein, the term “layer” refers to a functional programming component which interacts with other functional programming components in a sequential and/or hierarchical way. For example, the source code 108 may include different layers, such as an HTTP layer, an external service layer, a database layer, etc. The runtime data 110 can be located within the different layers of the source code 108.

In response to the computing device 102 locating the runtime data 110 in the source code 108 included in the execution trace 106, the computing device 102 is to annotate the runtime data 110. As used herein, the term “annotate” refers to adding a note to a text. For example, upon locating the runtime data 110, the computing device 102 can add a note to the source code 108 such as “@RD”. The runtime data 110 can, accordingly, be annotated within the source code 108 when located.

The computing device 102 can provide the annotated runtime data 110 to the computing device 124. For example, the computing device 102 can parse the source code 108 for the annotated runtime data 110 (e.g., by locating annotations such as @RD) to determine a value of the annotated runtime data 110. The computing device 102 can transmit the value for the annotated runtime data to the computing device 124. For example, the computing device 102 can parse the source code 108 to find annotated runtime data 110, such as the value of a variable “userld”, and pass the value of the variable userld (e.g., as well as related metadata information if applicable, such as the location of the variable userld inside the source code 108) to the computing device 124. A user of the computing device 124 can audit the web application 116 accordingly utilizing the annotated runtime data 110.

Annotating runtime data according to the disclosure can allow for location of runtime data in an execution trace of a web application. Such runtime data can be utilized to audit the web application in order to view various events associated with execution of the web application in order to examine suspicious activity and/or diagnose and/or troubleshoot issues experienced by the web application. Generating the execution trace of the web application via an omniscient debugger can allow for free exploration of the execution trace step-by-step forwards and/or backwards, avoiding having to rerun the web application many times as compared with previous approaches. Further, locating runtime data within the execution trace can be performed without having to manually search the source code, resulting in more efficient auditing of web applications as compared with previous approaches.

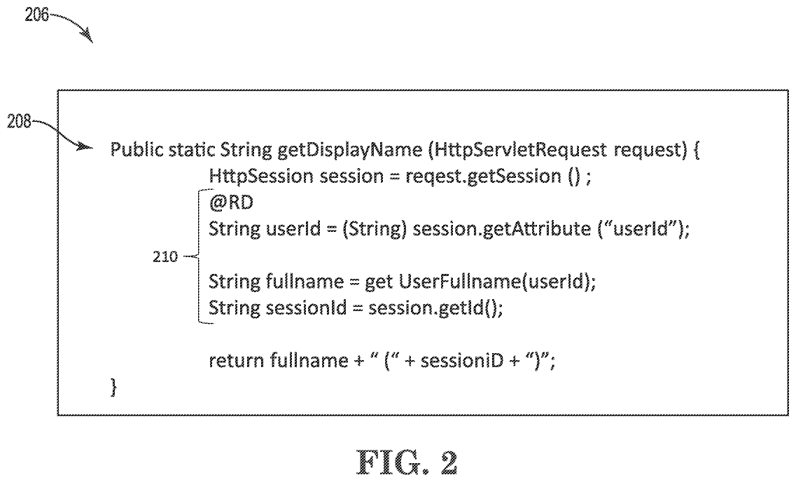

FIG. 2 illustrates an example of annotated runtime data 210 included in source code 208 in an execution trace 206 consistent with this disclosure. The source code 208 can be from a web application.

As illustrated in FIG. 2, an execution trace 206 can include a snippet of source code 208. The source code 208 can be, for example, source code of a web application. A portion of the source code 208 can be annotated runtime data 210, as is further described herein.

For example, a user may desire to audit the value of the variable “userld”. In previous approaches, the user may have to review the source code 208 manually to find and annotate the value of the variable “userld”, as well as manually change the method “getDisplayName” so that the method communicates with an auditor module (e.g., not illustrated in FIG. 2), which can add complexity to the source code 208.

Utilizing annotating runtime data according to the disclosure, a computing device can review the execution trace 206 to locate runtime data 210 as previously described in connection with FIG. 1. Accordingly, the computing device can annotate the runtime data (e.g., by adding “@RD” to the source code 208, as illustrated in FIG. 2). Accordingly, the computing device can parse the source code 208 to locate the annotated runtime data 210 (e.g., by locating @RD in the source code 208) to determine the value of the variable “userld” and value of the variable “userld” to another computing device for auditing the web application. Further, the computing device can locate and transmit metadata associated with the annotated runtime data 210 (e.g., metadata indicating the location of the variable “userld” in the source code 208, among other metadata).

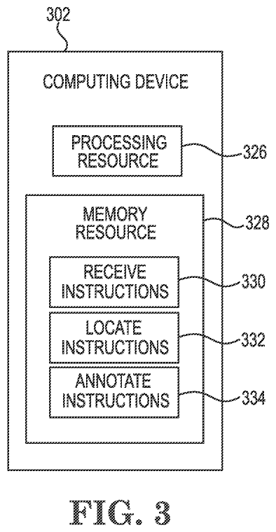

FIG. 3 illustrates an example of a computing device 302 for annotating runtime data consistent with this disclosure. As described herein, the computing device 302 may perform functions related to annotating runtime data. Although not illustrated in FIG. 3, the computing device 302 may include a processor and a machine-readable storage medium. Although the following descriptions refer to a single processor and a single machine-readable storage medium, the descriptions may also apply to a system with multiple processors and multiple machine-readable storage mediums. In such examples, the computing device 302 may be distributed across multiple machine-readable storage mediums and across multiple processors. Put another way, the instructions executed by the computing device 302 may be stored across multiple machine-readable storage media and executed across multiple processors, such as in a distributed or virtual computing environment.

Processing resource 326 may be a central processing unit (CPU), a semiconductor-based microprocessor, and/or other hardware devices suitable for retrieval and execution of machine-readable instructions 330, 332, 334 stored in a memory resource 328. Processing resource 326 may fetch, decode, and execute instructions 330, 332, 334. As an alternative or in addition to retrieving and executing instructions 330, 332, 334, processing resource 326 may include a plurality of electronic circuits that include electronic components for performing the functionality of instructions 330, 332, 334.

Memory resource 328 may be any electronic, magnetic, optical, or other physical storage device that stores executable instructions 330, 332, 334, and/or data. Thus, memory resource 328 may be, for example, Random Access Memory (RAM), an Electrically-Erasable Programmable Read-Only Memory (EEPROM), a storage drive, an optical disc, and the like. Memory resource 328 may be disposed within computing device 302, as shown in FIG. 3.

The computing device 302 may include instructions 330 stored in the memory resource 328 and executable by the processing resource 326 to receive an audit request for a web application. The audit request can be transmitted by another computing device (e.g., not illustrated in FIG. 3), where a user of the another computing device may desire to examine suspicious activity and/or diagnose and/or troubleshoot issues experienced by the web application.

The computing device 302 may include instructions 332 stored in the memory resource 328 and executable by the processing resource 326 to locate runtime data located in an execution trace of the web application in response to receiving the audit request. An omniscient debugger monitoring the web application can generate the execution trace and transmit the execution trace to a database. The execution trace can include source code in which runtime data is located. The computing device 302 can locate the runtime data via heuristics, a filtering model, searching via a predetermined search constraint, and/or consider the entirety of the execution trace as runtime data.

The computing device 302 may include instructions 334 stored in the memory resource 328 and executable by the processing resource 326 to annotate the runtime data in response to the runtime data being located. The computing device 302 can annotate the runtime data by adding a particular note to the source code that can be located when the computing device 302 parses the runtime data, determines a value of the runtime data, and passes the value of the runtime data to the another computing device for auditing the web application by a user.

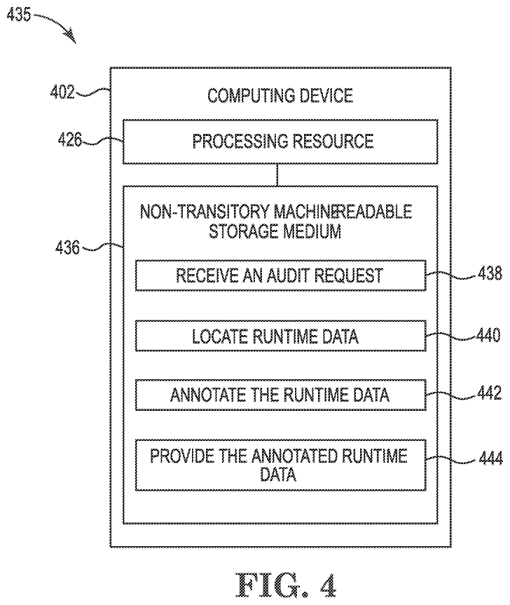

FIG. 4 illustrates a block diagram of an example system 435 for annotating runtime data consistent with this disclosure. In the example of FIG. 4, system 435 includes a computing device 402 including a processing resource 426 and a non-transitory machine-readable storage medium 436. Although the following descriptions refer to a single processing resource and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processing resource 426 may be a central processing unit (CPU), microprocessor, collection of multiple CPU's, and/or other hardware device suitable for retrieval and execution of instructions stored in the non-transitory machine-readable storage medium 436. In the particular example shown in FIG. 4, processing resource 426 may receive, determine, and send instructions 438, 440, 442, 444. As an alternative or in addition to retrieving and executing instructions, processing resource 426 may include an electronic circuit comprising a number of electronic components for performing the operations of the instructions in the non-transitory machine-readable storage medium 436. With respect to the executable instruction representations or boxes described and shown herein, it should be understood that part or all of the executable instructions and/or electronic circuits included within one box may be included in a different box shown in the figures or in a different box not shown.

The non-transitory machine-readable storage medium 436 may be any electronic, magnetic, optical, or other physical storage device that stores executable instructions. Thus, the non-transitory machine-readable storage medium 436 may be, for example, Random Access Memory (RAM), an Electrically-Erasable Programmable Read-Only Memory (EEPROM), a storage drive, an optical disc, and the like. The executable instructions may be “installed” on the system 435 illustrated in FIG. 4. The non-transitory machine-readable storage medium 436 may be a portable, external or remote storage medium, for example, that allows the system 435 to download the instructions from the portable/external/remote storage medium. In this situation, the executable instructions may be part of an “installation package”.

Receive an audit request 438, when executed by a processor such as processing resource 426, may cause system 435 to receive an audit request for a web application from an external computing device. A user of the external computing device may desire to examine suspicious activity and/or diagnose and/or troubleshoot issues experienced by the web application.

Locate runtime data 440, when executed by a processor such as processing resource 426, may cause system 435 to locate runtime data located in an execution trace of the web application in response to receiving the audit request. The execution trace is generated by an omniscient debugger monitoring the web application. The computing device 402 can locate the runtime data via heuristics, a filtering model, searching via a predetermined search constraint, and/or consider the entirety of the execution trace as runtime data.

Annotate the runtime data 442, when executed by a processor such as processing resource 426, may cause system 435 to annotate the runtime data in response to the runtime data being located. The computing device 402 can annotate the runtime data by adding a particular note to the source code.

Provide the annotated runtime data 444, when executed by a processor such as processing resource 426, may cause system 435 to provide the annotated runtime data to the external computing device. The computing device 402 can provide the annotated runtime data to the external computing device by parsing the source code for the annotated runtime data to determine a value of the annotated runtime data and transmitting the value for the annotated runtime data to the external computing device.

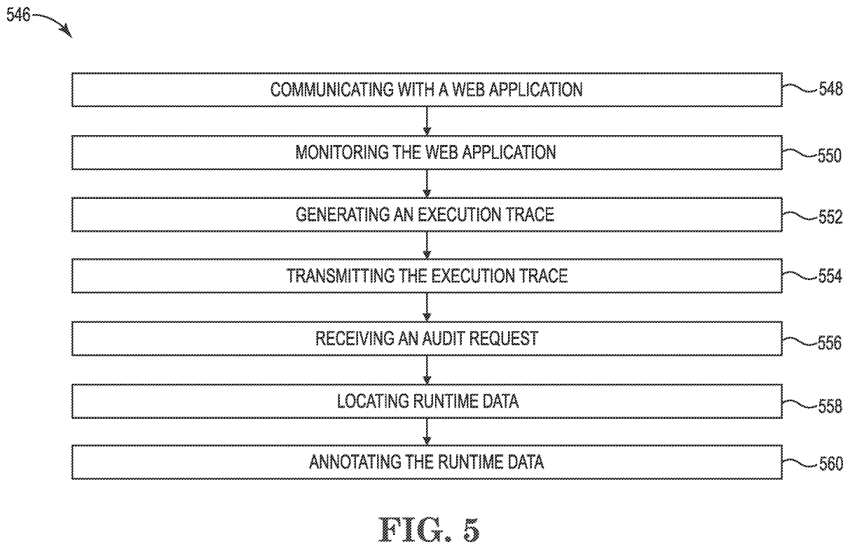

FIG. 5 illustrates an example of a method 546 for annotating runtime data consistent with this disclosure. The method 546 can be performed by various computing devices (e.g., computing devices 102, 112, 118, 124, 302, and 402, previously described in connection with FIGS. 1, 3 and 4) and an omniscient debugger (e.g., omniscient debugger 114, previously described in connection with FIG. 1).

At 548, the method 546 includes communicating, by a first computing device, with a web application. The first computing device communicates with the web application by transmitting HTTP requests and receiving HTTP responses.

At 550, the method 546 includes monitoring, by an omniscient debugger executing on a second computing device, the web application.

At 552, the method 546 includes generating, by the omniscient debugger, an execution trace associated with the web application. The execution trace includes source code of the web application as it was executed over a period of time.

At 554, the method 546 includes transmitting, by the second computing device, the execution trace to an external database.

At 556, the method 546 includes receiving, by a third computing device, an audit request for the web application from a fourth computing device.

At 558, the method 546 includes locating, by the third computing device, runtime data located in the execution trace in response to receiving the audit request. The third computing device locates the runtime data in the execution trace via heuristics, a filtering model, searching via a predetermined search constraint, and/or consider the entirety of the execution trace as runtime data.

At 560, the method 546 includes annotating, by the third computing device, the runtime data in the source code included in the execution trace in response to the runtime data being located.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 100 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A computing device, comprising:
a processing resource; and
a memory resource storing non-transitory machine-readable instructions to cause the processing resource to:
receive an audit request for a web application;
locate runtime data located in an execution trace of the web application in response to receiving the audit request, wherein the execution trace is generated by an omniscient debugger monitoring the web application; and
annotate the runtime data in response to the runtime data being located.

2. The computing device of claim 1, wherein the processing resource is to provide the annotated runtime data of the web application in response to receiving an audit request.

3. The computing device of claim 1, wherein the processing resource is to locate the runtime data located in the execution trace via heuristics.

4. The computing device of claim 1, wherein the processing resource is to locate the runtime data located in the execution trace via a filtering model.

5. The computing device of claim 1, wherein the processing resource is to locate the runtime data located in the execution trace by searching via a predetermined search constraint.

6. The computing device of claim 1, wherein the processing resource is to locate the runtime data located in the execution trace by considering the entirety of the execution trace as the runtime data.

7. The computing device of claim 1, wherein the runtime data is located within different layers within source code of the web application.

8. A non-transitory machine-readable storage medium including instructions that when executed cause a processor of a computing device to:
receive an audit request for a web application from an external computing device;
locate runtime data located in an execution trace of the web application in response to receiving the audit request, wherein the execution trace is generated by an omniscient debugger monitoring the web application;
annotate the runtime data in response to the runtime data being located; and
provide the annotated runtime data to the external computing device.

9. The medium of claim 8, wherein the execution trace generated by the omniscient debugger includes a recorded history of the monitored web application.

10. The medium of claim 9, wherein the recorded history includes source code of the web application as it was executed over a period of time.

11. The medium of claim 8, wherein the execution trace is located in a database.

12. The medium of claim 11, wherein the database is a remote database from the computing device.

13. A method, comprising:
communicating, by a first computing device, with a web application;
monitoring, by an omniscient debugger executing on a second computing device, the web application;
generating, by the omniscient debugger, an execution trace associated with the web application that includes source code of the web application as it was executed over a period of time;
transmitting, by the second computing device, the execution trace to an external database;
receiving, by a third computing device, an audit request for the web application from a fourth computing device;
locating, by the third computing device, runtime data located in the execution trace in response to receiving the audit request; and
annotating, by the third computing device, the runtime data in the source code included in the execution trace in response to the runtime data being located.

14. The method of claim 13, wherein the method includes providing, by the third computing device, the annotated runtime data by:
parsing the source code for the annotated runtime data to determine a value of the annotated runtime data; and
transmitting the value for the annotated runtime data to the fourth computing device.

15. The method of claim 13, wherein communicating with the web application includes:
transmitting, by the first computing device, a Hypertext Transfer Protocol (HTTP) request to the web application; and
receiving, by the first computing device, an HTTP response from the web application.
